(19) United States
(12) Patent Application Publication
(10) Pub. No.: US 2019/0072694 A1
(43) Pub. Date: Mar. 7, 2019

(54) LIGHT DIFFUSION FILM, COATING AGENT FOR FORMING LIGHT DIFFUSION FILM AND METHOD FOR MANUFACTURING SAME, PROJECTION SCREEN AND METHOD FOR MANUFACTURING SAME

(71) Applicant: NICCA CHEMICAL CO., LTD., Fukui-shi, Fukui (JP)

(72) Inventors: Takashi KITAMOTO, Fukui-shi, Fukui (JP); Shiori NODA, Fukui-shi, Fukui (JP); Hazime SAITO, Fukui-shi, Fukui (JP)

(21) Appl. No.: 16/083,914

(22) PCT Filed: Dec. 11, 2017
(86) PCT No.: PCT/JP2017/044400

§ 371 Date: Sep. 11, 2018

(30) Foreign Application Priority Data
Dec. 28, 2016 (JP) 2016-256305

(51) Int. Cl. G02B 5/02; G03B 21/60

(52) U.S. Cl. CPC G02B 5/0278; G02B 5/0268; G02B 5/0242; G03B 21/60

(57) ABSTRACT

A light diffusion film according to an aspect of the present invention includes a resin layer and a first particle and a bubble contained in the resin layer, and in the light diffusion film, the refractive index of the first particle is larger than the refractive index of the resin layer.

### TECHNICAL FIELD

The present invention relates to a light diffusion film, a coating agent for forming a light diffusion film and a method for manufacturing the same, and a projection screen and a method for manufacturing the same.

### BACKGROUND ART

As a projection screen, a reflective screen for projecting an image projected from a projector on a screen and visually recognizing the image projected on the screen from the projector side and a transmissive screen for projecting an image projected from a projector on a screen and visually recognizing the image projected on the screen from the opposite side to the projector are used in various fields. For example, reflective screens are used in advertising media such as home theaters, posters, and signboards and transmissive screens are used in advertising media such as digital signage.

As a reflective screen, for example, a screen type equipped with a reflective layer for reflecting light and a light diffusing layer for diffusing the reflected light is known, and as a transmissive screen, for example, a screen type equipped with a light diffusing layer for diffusing light is known. A projection screen is required to have a screen face (the face on the side on which the image is projected in the case of reflective screen and the face on the opposite side to the face on which the image is projected in the case of transmissive screen) exhibiting excellent visibility.

Patent Literature 1 discloses a reflective screen in which paper or a nonwoven fabric is used as a substrate, a synthetic resin layer having a thickness of 50 μm or less is provided on at least one face of the substrate, and light diffusing fine particles and a xerogel are provided on the synthetic resin layer.

Patent Literature 2 discloses a transmissive screen which is composed of a basal plate, a transparent thin film layer provided on the basal plate, and a light scattering medium which is contained in the transparent thin film layer and has a median diameter of from 0.01 to 1 μm, and in which the light scattering medium is diamond fine particles obtained by subjecting nano diamond which is obtained by an explosion method and has a graphite phase to an oxidation treatment.

### CITATION LIST

### Patent Literature

Patent Literature 1: Japanese Unexamined Patent Publication No. 2016-95406

Patent Literature 2: Japanese Unexamined Patent Publication No. 2011-113068

### SUMMARY OF INVENTION

### Technical Problem

In the case of Patent Literature 1, a xerogel is used, thus the heat resistance and light resistance are not sufficient and it cannot be said that the visibility is sufficient. In addition, in the case of Patent Literature 2, the surface reflectance is low, thus a sufficiently sharp image cannot be projected, the visibility as a reflective screen is not sufficient, and it cannot be said that the visibility as a transmissive screen is sufficient.

The present invention has been made in view of the above circumstances and an object thereof is to provide a light diffusion film exhibiting excellent visibility, a coating agent for forming the light diffusion film and a method for manufacturing the same, and a projection screen including the light diffusion film and a method for manufacturing the same.

### Solution to Problem

A light diffusion film according to an aspect of the present invention includes a resin layer and a first particle and a bubble contained in the resin layer, and in the light diffusion film, a refractive index of the first particle is larger than a refractive index of the resin layer. Such a light diffusion film exhibits excellent visibility.

The light diffusion film may further include a second particle having a refractive index smaller than the refractive index of the resin layer. In this case, the light diffusion film tends to exhibit superior visibility.

A coating agent for forming a light diffusion film according to an aspect of the present invention contains a resin composition, a first particle, and a bubble, and in the coating agent for forming a light diffusion film, a refractive index of the first particle is larger than a refractive index of a resin layer formed from the resin composition. In this case, a light diffusion film exhibiting excellent visibility is obtained.

The coating agent for forming a light diffusion film may further contain a second particle having a refractive index smaller than the refractive index of the resin layer. According to such a coating agent for forming a light diffusion film, it is possible to form a light diffusion film exhibiting superior visibility.

A coating agent for forming a light diffusion film according to another aspect of the present invention contains a resin composition, a first particle, and a blowing agent, and in the coating agent for forming a light diffusion film, a refractive index of the first particle is larger than a refractive index of a resin layer formed from the resin composition. In this case, a light diffusion film exhibiting excellent visibility is obtained.

The coating agent for forming a light diffusion film may further contain a second particle having a refractive index smaller than the refractive index of the resin layer. According to such a coating agent for forming a light diffusion film, it is possible to form a light diffusion film exhibiting superior visibility.

A method for manufacturing a coating agent for forming a light diffusion film according to an aspect of the present invention includes a step of introducing a bubble into a coating agent base containing a resin composition, a first particle having a refractive index larger than a refractive index of a resin layer formed from the resin composition, and a second particle which is contained depending on the circumstances and has a refractive index smaller than the refractive index of the resin layer.

A method for manufacturing a projection screen according to an aspect of the present invention includes a step of forming a particle-containing resin composition layer containing a resin composition, a first particle, and a bubble and a step of obtaining a light diffusion film including a resin layer and a first particle and a bubble contained in the resin layer by curing the particle-containing resin composition layer, and in the method, a refractive index of the first particle is larger than a refractive index of the resin layer formed from the resin composition. According to such a manufacturing method, a projection screen exhibiting excellent visibility can be obtained. The projection screen may be a reflective screen or a transmissive screen.

In the method for manufacturing a projection screen, the particle-containing resin composition layer may further include a second particle having a refractive index smaller than the refractive index of the resin layer. In this case, a projection screen exhibiting superior visibility is obtained.

In the method for manufacturing a projection screen, the particle-containing resin composition layer may be formed by coating a substrate with the above-described coating agent for forming a light diffusion film, which contains a resin composition, a first particle, and a bubble and a second particle to be contained depending on the circumstances.

In the method for manufacturing a projection screen, a coating agent for forming a light diffusion film, which is obtained by introducing a bubble into a coating agent base for forming a light diffusion film, which contains a resin composition and a first particle and a second particle to be contained depending on the circumstances may be used.

A method for manufacturing a projection screen according to another aspect of the present invention includes a step of forming a particle-containing resin composition layer containing a resin composition, a first particle, and a blowing agent and a step of obtaining a light diffusion film including a resin layer and a first particle and a bubble contained in the resin layer by performing bubbling of the blowing agent and curing of the particle-containing resin composition layer, and in the method, a refractive index of the first particle is larger than a refractive index of the resin layer formed from the resin composition. According to such a manufacturing method, a projection screen exhibiting excellent visibility is obtained. The projection screen may be a reflective screen or a transmissive screen.

In the method for manufacturing a projection screen, the particle-containing resin composition layer may further include a second particle having a refractive index smaller than the refractive index of the resin layer. In this case, a projection screen exhibiting superior visibility is obtained.

In the method for manufacturing a projection screen, the particle-containing resin composition layer may be formed by coating a substrate with the above-described coating agent for forming a light diffusion film, which contains a resin composition, a first particle, and a blowing agent, and a second particle to be contained depending on the circumstances.

A projection screen according to an aspect of the present invention includes the light diffusion film described above. Such a projection screen exhibits excellent visibility. The projection screen may be a reflective screen or a transmissive screen.

### Advantageous Effects of Invention

According to the present invention, it is possible to provide a light diffusion film exhibiting excellent visibility, a coating agent for forming the light diffusion film and a method for manufacturing the same, and a projection screen including the light diffusion film and a method for manufacturing the same.

### BRIEF DESCRIPTION OF DRAWINGS

FIG. 1 is a cross-sectional view illustrating a projection screen according to an embodiment of the present invention.

FIG. 2 is a cross-sectional view illustrating a projection screen according to an embodiment of the present invention.

FIG. 3 is a cross-sectional view illustrating a projection screen according to an embodiment of the present invention.

### DESCRIPTION OF EMBODIMENTS

Hereinafter, preferred embodiments of the present invention will be described in detail. However, the present invention is not limited to the following embodiments.

<Light Diffusion Film>

The light diffusion film according to the present embodiment includes a resin layer and first particles and bubbles contained in the resin layer, and in the light diffusion film, the refractive index of the first particle is larger than the refractive index of the resin layer. Such a light diffusion film exhibits excellent visibility. The reason why such an effect is obtained is not clear, but the present inventors presume that this is because the diffusibility of light by the first particles is improved by containing bubbles in the resin layer.

The light diffusion film according to the present embodiment may further include second particles having a refractive index smaller than the refractive index of the resin layer from the viewpoint of superior visibility. The reason why the light diffusion film exhibits superior visibility as it further includes the second particles is not clear, but the present inventors presume that this is because it is possible to decrease the refractive index of the portion containing the second particle in the resin layer to be smaller than that of the portion containing the first particle, it is thus possible to increase the refractive index difference between the portion containing the first particle and the portion containing the second particle, and as a result, the synergistic effect with the effect obtained by containing bubbles further improves the diffusibility of light by the first particles.

The thickness of the light diffusion film is not particularly limited, but it is preferably from 3 to 500 μm and more preferably from 5 to 400 μm from the viewpoint of superior visibility and excellent economic efficiency. Incidentally, the thickness of the light diffusion film in the present invention is measured by using, for example, a micrometer (for example, trade name: MDH-25M manufactured by Mitutoyo Corporation).

The light diffusion film according to the present embodiment is used in, for example, a projection screen (for example, a reflective screen and a transmissive screen). In the case of using the light diffusion film in a projection screen, the light diffusion film may singly constitute the projection screen or the projection screen may be constituted by providing the light diffusion film on a substrate.

Hereinafter, details of the resin layer, the first particles, the bubbles, and the second particles will be described. First, the resin layer will be described.

The resin layer contains at least a resin as a constituent. This resin functions, for example, as a matrix resin for fixing the first particles in the light diffusion film. The resin is not particularly limited, but specific examples thereof may include a polycarbonate resin, a polyurethane resin, a polyacrylic resin, a polystyrene resin, a polyolefin resin, a vinyl resin, a polyester resin, a polyether resin, a fluororesin, a polysulfone resin, a polyether ether ketone resin, a polyamide resin, a polyimide resin, a melamine resin, a phenol resin, an epoxy resin, a silicone resin, and a cellulose resin. A refractive index difference between the resin layer and the first particles is likely to be obtained and the visibility tends to be superior in the case of using these resins. From such a viewpoint, it is preferable that the resin layer contains at least either of a polyurethane resin or a polyacrylic resin. The resin layer may contain one kind of resin singly or two or more kinds of resins.

The resin layer may contain components other than the resin. Examples of other components may include various kinds of additives such as an anionic surfactant, a cationic surfactant, a nonionic surfactant, an amphoteric surfactant, a preservative, a light stabilizer, a ultraviolet absorber, an antioxidant, a polymerization inhibitor, a silicone antifoaming agent, a leveling agent, a thickener, a foam stabilizer, a precipitation inhibitor, a dripping preventing agent, a flame retardant, a fluorescent brightening agent, a viscosity stabilizer, a pH regulator, and organic and inorganic pigments and dyes, auxiliary additives, an antistatic agent, and a delustering agent.

It is preferable that the refractive index of the resin layer is in a range of from 1.40 to 1.60. It is preferable that the refractive index of the resin is in a range of from 1.40 to 1.60 from the viewpoint that such a resin layer is likely to be obtained. The refractive index in the present invention means a refractive index measured by an optical measuring method. The refractive index of the resin is a refractive index obtained by, for example, forming a 10 μm resin film and measuring the refractive index of the resin film by using an ellipsometer (trade name: Desktop Type Spectroscopic Ellipsometer FE-5000S manufactured by Yamato Scientific Co., Ltd.). The refractive index of the resin means the refractive index of a resin film formed from the mixture in a case in which the resin is a mixture of plural resins.

The content of the resin in the light diffusion film is preferably from 10% to 99% by mass and more preferably from 12% to 90% by mass based on the mass of the light diffusion film from the viewpoint that a refractive index difference between the resin layer and the first particles is likely to be obtained and the visibility is superior. In other words, the content of the resin in the light diffusion film may be 10% by mass or more or 12% by mass or more and 99% by mass or less or 90% by mass or less based on the mass of the light diffusion film from the viewpoint that a refractive index difference between the resin layer and the first particles is likely to be obtained and the visibility is superior.

Next, the first particles will be described.

The first particles are present in the resin layer, for example, in a dispersed state. The first particle is not particularly limited as long as it is a particle having a refractive index larger than the refractive index of the resin layer. The difference ([refractive index of first particle]-[refractive index of resin layer]) between the refractive index of the first particle and the refractive index of the resin layer is preferably 0.3 or more and more preferably 0.5 or more. The refractive index of the first particle is preferably 1.8 or more and more preferably 2.0 or more from the viewpoint of obtaining such a refractive index difference.

From the viewpoint of effectively scattering light, the component constituting the first particle may be diamond; metal oxides such as zirconium oxide, titanium oxide, barium titanate, strontium titanate, aluminum oxide, zinc oxide, copper oxide, cesium oxide, chromium oxide, niobium oxide, cerium oxide, indium tin oxide, and tantalum oxide; metals such as aluminum, nickel, cobalt, iron, titanium, chromium, zinc, tungsten, mercury, platinum, and molybdenum; and resins such as a polycarbonate resin, a polyurethane resin, a polyacrylic resin, a polystyrene resin, a polyvinyl alcohol resin, a polyolefin resin, a polyvinyl olefin resin, a polyester resin, a polyether resin, a fluororesin, a polysulfone resin, a polyether ether ketone resin, a polyamide resin, a polyimide resin, a melamine resin, a phenol resin, an epoxy resin, a silicone resin, and a cellulose resin. Among these, examples of those having a refractive index of 1.8 or more may include diamond; metal oxides such as zirconium oxide, titanium oxide, barium titanate, strontium titanate, zinc oxide, copper oxide, cesium oxide, chromium oxide, niobium oxide, cerium oxide, indium tin oxide, and tantalum oxide; and metals such as nickel, cobalt, iron, titanium, chromium, zinc, tungsten, mercury, platinum, and molybdenum, and examples of those having a refractive index of 2.0 or more may include diamond; metal oxides such as zirconium oxide, titanium oxide, barium titanate, strontium titanate, zinc oxide, copper oxide, cesium oxide, chromium oxide, niobium oxide, cerium oxide, indium tin oxide, and tantalum oxide; and metals such as cobalt, iron, titanium, chromium, zinc, tungsten, mercury, platinum, and molybdenum. Among these, diamond is preferable from the viewpoint that the viewing angle can be widened. The first particles may contain these components singly or two or more kinds of these components. In addition, as the first particles, one kind of particle composed of the same constituent may be used or plural kinds of particles having different constituents may be used.

The average particle diameter (primary particle diameter) of the first particles is preferably from 0.05 to 200 μm and more preferably from 0.1 to 100 μm from the viewpoint of visibility. In other words, the average particle diameter (primary particle diameter) of the first particles may be 0.05 μm or more or 0.1 μm or more and 200 μm or less or 100 μm from the viewpoint of visibility. Incidentally, the average particle diameter (primary particle diameter) in the present invention means a 50% median diameter based on the volume of particles, and it is an average particle diameter (primary particle diameter) measured by using a dynamic scattering type particle size analyzer (for example, LA-960 manufactured by Horiba, Ltd.)

The shape of the first particles is not particularly limited, and it may be, for example, a spherical shape, a substantially spherical shape, an ellipsoidal shape, a crushed shape, an irregular shape, a cubic shape, a rectangular parallelepiped shape, a plate shape, a pyramid shape, a conical shape, or a scaly shape.

The content of the first particles is preferably from 1% to 25% by mass and more preferably from 2% to 23% by mass based on the mass of the light diffusion film. In other words, the content of the first particles may be 1% by mass or more or 2% by mass or more and 25% by mass or less or 23% by mass or less based on the mass of the light diffusion film. The content of the first particles is sufficient and the visibility tends to be superior in a case in which the content of the first particles is 1% by mass or more. The first particles are likely to be present in a sufficiently dispersed state and the visibility tends to be superior in a case in which the content of the first particles is 25% by mass or less.

Next, the bubbles will be described.

The bubbles are present in the resin layer, for example, in a dispersed state. The component constituting the bubble is not particularly limited as long as it is gas at room temperature. Specifically, the component constituting the bubble may be at least one kind selected from the group consisting of hydrogen, helium, oxygen, fluorine, neon, chlorine, argon, krypton, xenon, radon, carbon monoxide, carbon dioxide, and air. The component constituting the bubble is preferably at least one kind selected from the group consisting of nitrogen, argon, carbon dioxide, and air and more preferably air from the viewpoint of economic efficiency and safety.

The shape of the bubbles is not particularly limited, and it may be, for example, a spherical shape, a substantially spherical shape, an ellipsoidal shape, or an irregular shape.

The average diameter of the bubbles is preferably from 0.01 to 100 μm and more preferably from 0.01 to 80 μm from the viewpoint of the smoothness of the surface of the light diffusion film. In other words, the average diameter of the bubbles may be 0.01 μm or more and 100 μm or less or 80 μm or less from the viewpoint of the smoothness of the surface of the light diffusion film. Incidentally, the average diameter in the present invention is determined by cutting the light diffusion film in a direction perpendicular to the main face of the film and observing the exposed cross section under a transmission electron microscope (TEM), a scanning electron microscope (SEM) or the like. Specifically, it is determined by measuring the diameters of the respective bubbles present in an arbitrary range of 10 mm² (√10 mm×√10 mm) of the exposed cross section and arithmetically averaging the measured diameters. Incidentally, the diameter of the largest circumscribed circle of the cross section of the bubble is measured in a case in which the shape of the bubble is not a perfect circle.

From the viewpoint of visibility, the volume proportion of the bubbles in the light diffusion film is preferably from 7.5% to 1000% by volume, more preferably from 10.0% to 500% by volume, and still more preferably from 12.5% to 100% by volume based on the volume of the portions excluding the bubbles in the light diffusion film (the sum of the volumes of the resin, the first particles, and the second particles in the case of further including the second particles). In other words, the volume proportion of the bubbles in the light diffusion film may be 7.5% by volume or more, 10.0% by volume or more, or 12.5% by volume or more and 1000% by volume or less, 500% by volume or less, or 100% by volume or less based on the volume of the portions excluding the bubbles in the light diffusion film (the sum of the volumes of the resin, the first particles, and the second particles in the case of further including the second particles) from the viewpoint of visibility. The volume proportion of the bubbles in the light diffusion film can be adjusted by, for example, changing the volume proportion of the bubbles in the coating agent for forming a light diffusion film. In addition, the volume proportion of the bubbles can also be adjusted by, for example, changing the temperature (curing temperature) when curing the particle-containing resin composition layer obtained by coating a substrate with the coating agent for forming a light diffusion film. The amount of bubbles evaporated tends to increase in a case in which the curing temperature is high, and the amount of bubbles evaporated tends to decrease in a case in which the curing temperature is low. In addition, the volume proportion of the bubbles can also be adjusted by changing the content of the blowing agent, for example, in a case in which the coating agent for forming a light diffusion film contains a blowing agent to be described later. Incidentally, the volume proportion in the present invention is determined by cutting the light diffusion film in a direction perpendicular to the main face of the film and observing the exposed cross section under a transmission electron microscope (TEM), a scanning electron microscope (SEM) or the like. Specifically, the cross section is observed in an arbitrary range of 10 mm² (√10 mm×√10 mm) of the exposed cross section and the area proportion occupied by bubbles in the cross section in the observed photograph is measured. Such measurement is performed at arbitrary three cross sections and the arithmetic average of the area proportions at the three cross sections is calculated to calculate the volume proportion of bubbles.

Next, the second particles will be described.

The second particles are present in the resin layer, for example, in a dispersed state. The second particle is not particularly limited as long as it is a particle having a refractive index smaller than the refractive index of the resin layer. The difference ([refractive index of resin layer]−[refractive index of second particle]) between the refractive index of the resin layer and the refractive index of the second particle is preferably 0.1 or more and more preferably 0.7 or more from the viewpoint of superior visibility. The refractive index of the second particle is preferably 1.40 or less and more preferably 0.80 or less from the viewpoint of obtaining such a refractive index difference.

Examples of the component constituting the second particles may include magnesium fluoride, calcium fluoride, lithium fluoride, copper, silver, and gold. Examples of the second particle having a difference between the refractive index of the resin layer and the refractive index of the second particle of 0.70 or more may include gold, silver, and copper.

The shape of the second particle is not particularly limited, and it may be, for example, a spherical shape, a substantially spherical shape, an ellipsoidal shape, a crushed shape, an irregular shape, a cubic shape, a rectangular parallelepiped shape, a plate shape, a pyramid shape, a conical shape, or a scaly shape.

The average particle diameter (primary particle diameter) of the second particles is preferably from 0.01 to 100 μm and more preferably from 0.01 to 80 μm from the viewpoint of superior visibility. In other words, the average particle diameter (primary particle diameter) of the second particles may be 0.01 μm or more and 100 μm or less or 80 μm or less from the viewpoint of superior visibility.

The content of the second particles is preferably more than 0% by mass and 85% by mass or less and more preferably from 2% to 85% by mass based on the mass of the light diffusion film. In other words, the content of the second particles may be more than 0% by mass or 2% by mass or more and 85% by mass or less based on the mass of the light diffusion film. The content of the second particles is sufficient and the visibility tends to be superior in a case in which the content of the second particles is 2% by mass or more. The second particles are likely to be present in a sufficiently dispersed state and the visibility tends to be superior in a case in which the content of the second particles is 85% by mass or less.

<Coating Agent for Forming Light Diffusion Film>

Next, a coating agent (a coating agent for forming a light diffusion film) to be used for forming a light diffusion film according to the present embodiment will be described.

### First Embodiment

The coating agent for forming a light diffusion film according to the first embodiment contains a resin composition, first particles and bubbles. It is preferable that the coating agent for forming a light diffusion film contains second particles from the viewpoint of superior visibility of the light diffusion film to be obtained. The coating agent for forming a light diffusion film according to the present embodiment is suitable for an application to form a light diffusion film to be used in a projection screen, and particularly it is suitable for an application to form a light diffusion film to be used in a reflective screen and an application to form a light diffusion film to be used in a transmissive screen.

First, the resin composition to be contained in the coating agent for forming a light diffusion film will be described.

The resin composition is a component which forms the resin layer described above by being cured. The resin composition contains at least either of a resin such as a polycarbonate resin, a polyurethane resin, a polyacrylic resin, a polystyrene resin, a polyolefin resin, a vinyl resin, a polyester resin, a polyether resin, a fluororesin, a polysulfone resin, a polyether ether ketone resin, a polyamide resin, a polyimide resin, a melamine resin, a phenol resin, an epoxy resin, a silicone resin, or a cellulose resin or a raw material of the resin. The raw material of the resin may be, for example, a polymerizable monomer (for example, a monomer mixture) which constitutes the resin described above by being polymerized by heat, light, or the like and a polymerization initiator. In a case in which the resin composition contains at least either of the resin described above or a raw material of the resin, the dispersibility of the first particles and the second particles is excellent and thus a light diffusion film exhibiting excellent visibility is likely to be obtained. Incidentally, a commercially available resin solution (for example, a resin dispersion) in which the resin described above is diluted with or dispersed in a solvent may be used in the present embodiment.

Examples of the polymerizable monomer may include (meth)acrylic acid; (meth)acrylic acid ester-based compounds such as ethyl (meth)acrylate, methyl (meth)acrylate, 2-ethylhexyl (meth)acrylate, isobutyl (meth)acrylate, hydroxyethyl (meth)acrylate, hydroxypropyl (meth)acrylate and 4-hydroxybutyl (meth)acrylate; alkene compounds such as ethylene, propylene, butene, hexene, butadiene, and isoprene; halogenated alkene compounds such as chloroethylene and dichloroethylene; cycloalkene compounds such as cyclohexene; styrene; and epoxy compounds such as ethylene oxide and propylene oxide. The polymerizable monomer may be the resin having a polymerizable functional group.

Examples of the polymerization initiator may include thermal radical polymerization initiators such as an azo compound and a peroxide; thermal cationic polymerization initiators such as benzenesulfonic acid ester compound and an alkyl sulfonium salt; and photopolymerization initiators such as a benzoin compound and an acetophenone compound.

The content of solid components in the resin composition is preferably from 10% to 99% by mass and more preferably from 12% to 90% by mass based on the total mass of solid components in the coating agent for forming a light diffusion film from the viewpoint of excellent dispersibility of the first particles and the second particles and ease of coating. In other words, the content of solid components in the resin composition may be 10% by mass or more or 12% by mass or more and 99% by mass or less or 90% by mass or less based on the total mass of solid components in the coating agent for forming a light diffusion film from the viewpoint of excellent dispersibility of the first particles and the second particles and ease of coating. Incidentally, the term “solid components” refers to components remaining when the coating agent for forming a light diffusion film is formed into a light diffusion film.

The resin composition can contain various kinds of additives such as a polymerization initiator, an anionic surfactant, a cationic surfactant, a nonionic surfactant, an amphoteric surfactant, a preservative, a light stabilizer, a ultraviolet absorber, an antioxidant, a polymerization inhibitor, a silicone antifoaming agent, a leveling agent, a thickener, a foam stabilizer, a precipitation inhibitor, a dripping preventing agent, a flame retardant, a fluorescent brightening agent, a viscosity stabilizer, a pH regulator, and organic and inorganic pigments and dyes, auxiliary additives, and other additives such as an antistatic agent and a delustering agent if necessary.

It is preferable that the resin composition contains at least either of a foam stabilizer or a thickener from the viewpoint of bubble stabilization.

The foam stabilizer is not particularly limited as long as it stably forms bubbles, specific examples thereof may include a gelling agent, a silicone-based foam stabilizer, and a polyurethane foam stabilizer, and a gelling agent and a polyurethane foam stabilizer are preferable from the viewpoint of the dispersibility of the first particles and the second particles.

The content of the foam stabilizer is preferably from 1% to 15% by mass and more preferably from 2% to 10% by mass based on the total mass of the coating agent for forming a light diffusion film from the viewpoint of stabilization of bubbles and the dispersibility of the first particles and the second particles. In other words, the content of the foam stabilizer may be 1% by mass or more or 2% by mass or more and 15% by mass or less or 10% by mass or less based on the total mass of the coating agent for forming a light diffusion film from the viewpoint of stabilization of bubbles and the viewpoint of the dispersibility of the first particles and the second particles.

Examples of the thickener may include a polycarboxylic acid compound, a polyurethane compound, a polyethylene glycol fatty acid ester compound, a polyether compound, and a thickening polysaccharide, and a polycarboxylic acid compound, a polyurethane compound, and a polyethylene glycol fatty acid ester compound are preferable from the viewpoint of the dispersibility of the first particles and the second particles.

The content of the thickener is preferably from 0.01% to 4% by mass and more preferably from 0.05% to 2% by mass based on the total mass of the coating agent for forming a light diffusion film from the viewpoint of stabilization of bubbles and the viewpoint of the dispersibility of the first particles and the second particles. In other words, the content of the thickener may be 0.01% by mass or more or 0.05% by mass or more and 4% by mass or less or 2% by mass or less based on the total mass of the coating agent for forming a light diffusion film from the viewpoint of stabilization of bubbles and the viewpoint of the dispersibility of the first particles and the second particles.

Next, the first particles and bubbles contained in the coating agent for forming a light diffusion film and the second particles to be contained depending on the circumstances will be described.

As the first particles and the second particles, the first particles and the second particles in the light diffusion film described above are used.

The content of the first particles is preferably from 1% to 25% by mass and more preferably from 2% to 23% by mass based on the total mass of solid components in the coating agent for forming a light diffusion film from the viewpoint of excellent dispersibility of the first particles and superior visibility of the light diffusion film to be obtained. In other words, the content of the first particles may be 1% by mass or more or 2% by mass or more and 25% by mass or less or 23% by mass or less based on the total mass of solid components in the coating agent for forming a light diffusion film from the viewpoint of excellent dispersibility of the first particles and superior visibility of the light diffusion film to be obtained.

The content of the second particles is preferably from 0% to 85% by mass and more preferably from 2% to 85% by mass based on the total mass of solid components in the coating agent for forming a light diffusion film from the viewpoint of excellent dispersibility of the second particles and superior visibility of the light diffusion film to be obtained. In other words, the content of the second particles may be 0% by mass or more or 2% by mass or more and 85% by mass or less based on the total mass of solid components in the coating agent for forming a light diffusion film from the viewpoint of excellent dispersibility of the second particles and superior visibility of the light diffusion film to be obtained.

The component constituting the bubbles, the shape of the bubbles, and the average diameter of the bubbles may be the same as those of the bubbles in the light diffusion film described above.

The volume proportion of bubbles in the coating agent for forming a light diffusion film is preferably from 7.5% to 1000% by volume, more preferably from 10.0% to 500% by volume, and still more preferably from 12.5% to 100% by volume based on the volume of the portions excluding the bubbles in the coating agent from the viewpoint of easily obtaining a light diffusion film exhibiting excellent visibility. In other words, the volume proportion of bubbles in the coating agent for forming a light diffusion film may be 7.5% by volume or more, 10.0% by volume or more, or 12.5% by volume or more and 1000% by volume or less, 500% by volume or less, or 100% by volume or less based on the volume of the portions excluding the bubbles in the coating agent from the viewpoint of easily obtaining a light diffusion film exhibiting excellent visibility.

The coating agent for forming a light diffusion film may further contain a solvent.

Examples of the solvent may include aliphatic hydrocarbon-based solvents such as hexane, cyclohexane, methylcyclohexane, ethylcyclohexane, heptane, nonane, octane, isooctane and decane; aromatic hydrocarbon-based solvents such as benzene, toluene, xylene, cumene, and ethylbenzene; ether-based solvents such as diethyl ether, diisopropyl ether, methyl-tert-butyl ether, methyl cellosolve, cellosolve, butyl cellosolve, methyl carbitol, carbitol, butyl carbitol, diethyl carbitol, propylene glycol monomethyl ether, dipropylene glycol monomethyl ether, tetrahydrofuran, 1,3-dioxane, and 1,4-dioxane; ketone-based solvents such as dimethyl ketone, ethyl methyl ketone, diethyl ketone, methyl isobutyl ketone, diisopropyl ketone, diisobutyl ketone, and cyclohexanone; carbonic acid ester-based solvents such as dimethyl carbonate, diethyl carbonate, and ethylene carbonate; alcohol-based solvents such as methyl alcohol, ethyl alcohol, isopropyl alcohol, n-butyl alcohol, isobutyl alcohol, sec-butyl alcohol, cyclohexanol, diacetone alcohol, 3-methoxy-3-methyl-1-butanol, ethylene glycol and propylene glycol; ester-based solvents such as ethyl acetate, n-butyl acetate, isobutyl acetate, n-amyl acetate, propylene glycol monomethyl ether acetate, and 3-methoxy-3-methyl-1-butyl acetate; nitrile-based solvents such as acetonitrile; aliphatic amide-based solvents such as N,N-dimethylformamide, N,N-dimethylacetamide, alkoxy-N-isopropyl-propionamide, and hydroxyalkylamide; alicyclic amide-based solvents such as N-methyl-2-pyrrolidone and N-ethyl-pyrrolidone; and water. These can be used singly or in combination of two or more kinds thereof.

The content of the solvent in the coating agent for forming a light diffusion film is preferably from 10% to 95% by mass and more preferably from 13% to 90% by mass based on the total mass of the coating agent for forming a light diffusion film from the viewpoint of coating. In other words, the content of the solvent in the coating agent for forming a light diffusion film may be 10% by mass or more or 13% by mass or more and 95% by mass or less or 90% by mass or less based on the total mass of the coating agent for forming a light diffusion film from the viewpoint of coating.

The method for manufacturing a coating agent for forming a light diffusion film according to the present embodiment is not particularly limited, but the method may be equipped with, for example, a step of obtaining a coating agent base for forming a light diffusion film, which contains a resin composition, first particles, and second particles and additives depending on the circumstances by adding and dispersing the first particles and further the second particles and the other additives described above, if necessary, in the resin composition and a step of introducing bubbles into the coating agent base.

Examples of a method for dispersing the first particles and further the second particles depending on the circumstances in the resin composition may include conventionally known methods (mixing method and dispersion method). It is preferable to perform a dispersion treatment by using a dispersing machine in order to more reliably disperse the first particles and the second particles. Examples of the dispersing machine may include mixers such as a disper, a homomixer, a planetary mixer (trade name “FILMIX” manufactured by PRIMIX Corporation), a planetary centrifugal mixer (trade name “Awatori Rentaro” manufactured by THINKY CORPORATION and the like); a homogenizer (trade name “CLEARMIX” manufactured by M Technique Co., Ltd.); media type dispersing machines such as a paint conditioner (manufactured by Red Devil), a ball mill, a sand mill (trade name “DYNO-MILL” manufactured by SHINMARU ENTERPRISES CORPORATION and the like), an attritor, a pearl mill (trade name “DCP mill” manufactured by Nippon Eirich Co., Ltd. and the like), and CoBall-Mill; wet jet mills (trade name “Genus PY” manufactured by Genus Electrotech Co., Ltd., trade name “Star Burst” manufactured by SUGINO MACHINE LIMITED, trade name “NANOMIZER” manufactured by NANOMIZER Inc., and the like); media-less dispersing machines (trade name “CLEAR SS-5” manufactured by M Technique Co., Ltd., trade name “MICROS” manufactured by Nara Machinery Co., Ltd., and the like); and other roll mills. The number of revolutions of the mixers when dispersing the first particles and further the second particles depending on the circumstances in the resin composition is, for example, from 100 to 6000 rpm.

In the step of introducing bubbles, bubbles are formed in the coating agent base for formng a light diffusion film, for example, by performing high-speed stirring of resin, bubble injection, and the like. Specifically, it is possible to introduce bubbles into the coating agent base for forming a light diffusion film by a method in which the coating agent base for forming a light diffusion film is stirred at a high speed by using a mixer (for example, “Ken Mix Aicoh Premier” manufactured by Aicohsha Manufacturing Co., Ltd.), a method in which bubbles are injected into the coating agent base for forming a light diffusion film by using a bubble generator (for example, “Micro Bubbler” manufactured by JAPAN ARTIST BUREAU CO., LTD.), or the like. The number of revolutions of the mixers when forming bubbles is, for example, from 10 rpm to 1000 rpm.

It is preferable that the coating agent for forming a light diffusion film is usually stored in a state of the coating agent base for forming a light diffusion film (a state in which the first particles and further the second particles depending on the circumstances are added to and dispersed in the resin composition) and shipped. It is preferable to introduce bubbles into the coating agent base for forming a light diffusion film immediately before forming the light diffusion film (for example, immediately before manufacturing the projection screen) from the viewpoint of stability of bubbles.

### Second Embodiment

Hereinafter, a coating agent for forming a light diffusion film according to a second embodiment of the present invention will be described. The second embodiment is the same as the first embodiment except the matters to be described below.

The coating agent for forming a light diffusion film according to the second embodiment contains a resin composition, a first particle, and a blowing agent. It is preferable that the coating agent for forming a light diffusion film contains a second particle from the viewpoint of superior visibility of the light diffusion film to be obtained. In addition, the coating agent for forming a light diffusion film may contain bubbles as in the first embodiment.

The blowing agent may be an organic blowing agent or an inorganic blowing agent. Examples of the organic blowing agent may include azodicarbonamide, dinitrosopentamethylenetetramine, and p,p′-oxybisbenzenesulfonylhydrazide. Examples of the inorganic blowing agent may include sodium hydrogen carbonate and sodium hydrogen borate.

The content of the blowing agent is preferably from 0.1% to 10% by mass and more preferably from 1% to 5% by mass based on the total mass of solid components in the coating agent for forming a light diffusion film from the viewpoint of easily adjusting the content of bubbles in the light diffusion film to the above preferred range. In other words, the content of the blowing agent may be 0.1% by mass or more or 1% by mass or more and 10% by mass or less or 5% by mass or less based on the total mass of solid components in the coating agent for forming a light diffusion film from the viewpoint of easily adjusting the content of bubbles in the light diffusion film to the above preferred range.

The coating agent for forming a light diffusion film may contain a blowing auxiliary. Examples of the blowing auxiliary may include an anionic surfactant, a cationic surfactant, a nonionic surfactant, an amphoteric surfactant, an amine oxide, and the foam stabilizer described above.

<Projection Screen and Method for Manufacturing the Same>

Next, a projection screen and a method for manufacturing the same according to the present embodiment will be described.

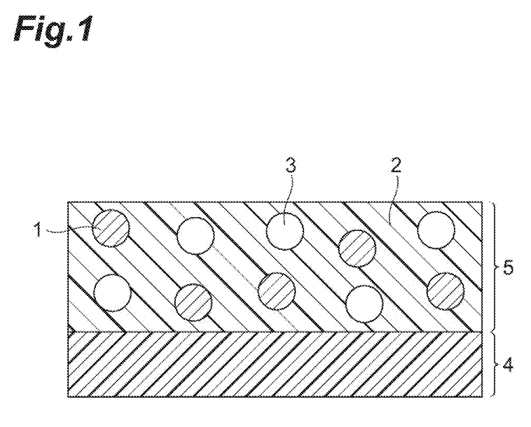

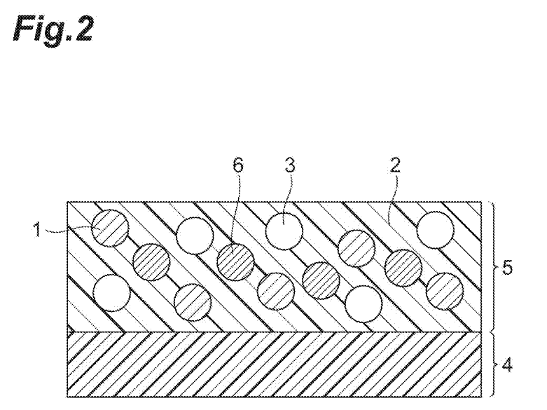

FIG. 1 is a cross-sectional view illustrating a projection screen according to the present embodiment. The projection screen illustrated in FIG. 1 may be a reflective screen or a transmissive screen. As illustrated in FIG. 1, the projection screen according to the present embodiment is equipped with a substrate 4 and a light diffusion film 5 provided on the substrate 4. The light diffusion film 5 includes a resin layer 2 and a first particle 1 and a bubble 3 contained in the resin layer 2. As illustrated in FIG. 2, the light diffusion film 5 further includes a second particle 6 contained in the resin layer 2 depending on the circumstances. Incidentally, the details of the light diffusion film 5 are as described above.

The substrate 4 is not particularly limited as long as it does not impair the optical characteristics of the projection screen. Specific examples of the substrate 4 to be used in a reflective screen may include oxidized glass such as silicate glass, phosphate glass, and borate glass; silicate glass such as silica glass, alkaline silicate glass, soda lime glass, potash lime glass, lead glass, barium glass, and borosilicate glass; plastics such as a polyester-based resin, a polycarbonate-based resin, a polyolefin-based resin, a polyacrylic resin, a cellulose-based resin, and a polyvinyl-based resin; quartz; metal oxides such as aluminum oxide, titanium oxide, niobium oxide, tantalum oxide, indium tin oxide, zinc oxide, zirconium oxide, and cerium oxide; alloys such as steel, carbon steel, chromium-molybdenum steel, an aluminum alloy, a stainless steel alloy, a copper alloy, and a titanium alloy; metals such as gold, silver, copper, zinc, iron, aluminum, platinum, lead, and palladium; vegetable fibers such as cotton and hemp; animal fibers such as silk, wool, alpaca, angora, cashmere, and mohair; synthetic fibers such as rayon, polyacetate, promix, nylon, polyester, polyacryl, polyvinyl chloride, and polyurethane; and inorganic fibers such as a glass fiber, a metal fiber, and a carbon fiber. Specific examples of the substrate 4 to be used in a transmissive screen may include oxidized glass such as silicate glass, phosphate glass, and borate glass; silicate glass such as silica glass, alkaline silicate glass, soda lime glass, potash lime glass, lead glass, barium glass, and borosilicate glass; plastics such as a polyester-based resin, a polycarbonate-based resin, a polyolefin-based resin, a polyacrylic resin, a cellulose-based resin, and a polyvinyl-based resin; quartz; vegetable fibers such as cotton and hemp; animal fibers such as silk, wool, alpaca, angora, cashmere, and mohair; synthetic fibers such as rayon, polyacetate, promix, nylon, polyester, polyacryl, polyvinyl chloride, and polyurethane; and inorganic fibers such as a glass fiber, a metal fiber, and a carbon fiber.

The thickness of the substrate 4 is not particularly limited, but it is preferably 10 μm or more or 20 μm or more and 50 mm or less or 30 mm or less from the viewpoint of strength and economic efficiency. In other words, the thickness of the substrate 4 is preferably from 10 μm to 50 mm and more preferably 20 μm to 30 mm from the viewpoint of strength and economic efficiency. It is preferable that the thickness of the substrate is in the above range in both of a case in which the projection screen is a reflective screen and a case in which the projection screen is a transmissive screen.

A first aspect of the method for manufacturing the projection screen according to the present embodiment is equipped with a step of forming a particle-containing resin composition layer containing a resin composition, a first particle 1, and a bubble 3 and a step of obtaining a light diffusion film 5 having a resin layer 2 and the first particle 1 and the bubble 3 contained in the resin layer 2 by curing the particle-containing resin composition layer.

In the present aspect, it is preferable that the particle-containing resin composition layer further contains a second particle 6 having a refractive index smaller than the refractive index of the resin layer 2. In this case, the light diffusion film 5 having the resin layer 2 and the first particle 1, the second particle 6 and the bubbles 3 contained in the resin layer 2 is obtained by curing the particle-containing resin composition layer.

The particle-containing resin composition layer can be formed, for example, by coating (for example, applying) the coating agent for forming a light diffusion film (a coating agent for forming a light diffusion film, which contains the resin composition, the first particle 1 and the bubble 3 or a coating agent for forming a light diffusion film, which contains the resin composition, the first particle 1, the second particle 6 and the bubble 3) according to the first embodiment on the substrate 4.

The method for coating the coating agent for forming a light diffusion film on the substrate 4 is not particularly limited and can be appropriately selected depending on the shape of the substrate 4. Examples thereof may include methods such as a slide bead method, a slide curtain method, an extrusion method, a slot die method, a gravure roll method, an air knife method, a blade coating method, and a rod bar coating method.

From the viewpoint of visibility and economic efficiency, the thickness of the coating film of the coating agent for forming a light diffusion film is preferably a thickness so that the thickness of the particle-containing resin composition layer after being dried (for example, the thickness of the light diffusion film 5) becomes from 3 to 500 μm and more preferably a thickness so that the thickness of the particle-containing resin composition layer after being dried becomes from 5 to 400 μm. In other words, from the viewpoint of visibility and economic efficiency, the thickness of the coating film of the coating agent for forming a light diffusion film may be a thickness so that the thickness of the particle-containing resin composition layer after being dried (for example, the thickness of the light diffusion film 5) becomes 3 μm or more or 5 μm or more and a thickness so that the thickness of the particle-containing resin composition layer after being dried (for example, the thickness of the light diffusion film 5) becomes 500 μm or less or 400 μm or less.

The method for curing the particle-containing resin composition layer is not particularly limited. For example, in a case in which the resin composition in the particle-containing resin composition layer contains a resin solution (for example, a resin dispersion) in which the resin is diluted with or dispersed in a solvent, the resin may be cured by subjecting the particle-containing resin composition layer to a drying treatment to evaporate the solvent in the particle-containing resin composition layer by a method in which the particle-containing resin composition layer is heated by using a hot air dryer or the like. In a case in which the resin composition contains a polymerizable monomer, the particle-containing resin composition layer can be cured by heating the particle-containing resin composition layer to remove the solvent contained in the particle-containing resin composition layer, if necessary, and then irradiating the particle-containing resin composition layer with active energy rays such as ultraviolet ray (UV), electron beam (EB), infrared ray, visible light, X ray, electron beam, α ray, β ray, and γ ray. In addition, the polymerizable monomer can be polymerized by blending a polymerization initiator into the resin composition if necessary.

A second aspect of the method for manufacturing the projection screen according to the present embodiment is equipped with a step of forming a particle-containing resin composition layer containing a resin composition, a first particle, and a blowing agent and a step of obtaining a light diffusion film including a resin layer and the first particle and the bubble contained in the resin layer by performing bubbling of the blowing agent and curing of the particle-containing resin composition layer.

It is preferable that the particle-containing resin composition layer further contains a second particle 6 having a refractive index smaller than the refractive index of the resin layer 2. In this case, the light diffusion film 5 having the resin layer 2 and the first particle 1, the second particle 6 and the bubbles 3 contained in the resin layer 2 is obtained by curing the particle-containing resin composition layer.

The particle-containing resin composition layer can be formed, for example, by coating (for example, applying) the coating agent for forming a light diffusion film (a coating agent for forming a light diffusion film, which contains the resin composition, the first particle 1 and the blowing agent or a coating agent for forming a light diffusion film, which contains the resin composition, the first particle 1, the second particle 6 and the blowing agent) according to the second embodiment on the substrate 4. The method for coating the coating agent for forming a light diffusion film on the substrate 4 and the thickness of the coating film of the coating agent for forming a light diffusion film may be the same as those in the first aspect.

Examples of a method for allowing the blowing agent to bubble in the step of obtaining a light diffusion film may include a method in which the particle-containing resin composition layer is heated by being subjected to a heat treatment. In the present step, curing of the particle-containing resin composition layer may be performed after the blowing agent has bubbled or curing of the particle-containing resin composition may be performed while the blowing agent bubbles. For example, bubbling of the blowing agent and curing of the particle-containing resin composition layer may be performed by one time of heating or the blowing agent may be allowed to bubble by heating the particle-containing resin composition layer at a temperature at which the particle-containing resin composition layer is not cured and then the particle-containing composition layer may be cured by being heated again. The method for curing the particle-containing resin composition layer may be the same as that in the first aspect.

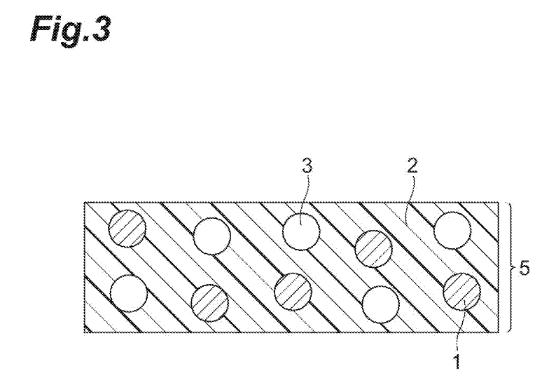

In another embodiment, the projection screen (for example, a reflective screen and a transmissive screen) may be composed only of the light diffusion film 5 as illustrated in FIG. 3. In the case of manufacturing a projection screen composed only of the light diffusion film 5, for example, a projection screen composed only of the light diffusion film 5 is obtained by using a release substrate as the substrate 4. Specifically, a projection screen is obtained by forming a particle-containing cured material layer on a release substrate and curing the particle-containing cured material layer to obtain the light diffusion film 5 and then finally removing the light diffusion film 5 from the release substrate. The method for peeling off the light diffusion film 5 from the release substrate is not particularly limited, but examples thereof may include methods such as seal peeling, physical peeling, and addition of a release agent.

The release substrate is not particularly limited as long as it is used as a usual release substrate, but examples thereof may include wood free paper, arc paper, mirror coated paper, a nonwoven fabric, an aluminum foil, a gold foil, a silver foil, a polyester film, a polyolefin film, a polyvinyl acetate film, a polystyrene film, a polyvinyl chloride film, and a polyimide film. In addition, the surface of the substrate may be subjected to a surface treatment such as silicone processing, polyethylene lamination processing, clay coating, or application of a release agent so that the light diffusion film 5 is easily peeled off from the release substrate.

In the projection screen according to the present embodiment, it is also possible to provide a known hard coat layer for increasing the strength of the film, a diffusion preventing layer, an antistatic layer, a fingerprint preventing film layer, a delustering layer, and the like on at least one outermost surface of the projection screen.

### EXAMPLES

Hereinafter, the present invention will be described in detail with reference to Examples, but the contents of the present invention is not limited to Examples.

<Preparation of Coating Agent for Forming Light Diffusion Film>

As described below, materials and a substrate for preparing a coating agent for forming a light diffusion film were prepared.

[Resin Solution]
Urethane resin dispersion: EVAFANOL HA-170 (trade name, manufactured by NICCA CHEMICAL CO., LTD., nonvolatile components: 36.5% by mass, refractive index: 1.50)
Acrylic resin dispersion: one prepared by diluting EK-61 (trade name, manufactured by SAIDEN CHEMICAL INDUSTRY CO., LTD., nonvolatile components: 43% by mass, refractive index: 1.49) with deionized water to adjust the nonvolatile components to 36.5% by mass

[First Particle]
Diamond 1: (manufactured by The Nano Group, Inc., primary particle diameter: 208 nm, refractive index: 2.41)
Diamond 2: (manufactured by L.M. Van Moppes & Sons SA, primary particle diameter: 670 nm, refractive index: 2.41)

[Second Particle]
Gold particle: (manufactured by Sigma-Aldrich Japan, primary particle diameter: 900 nm, refractive index: 0.34)

[Thickener]
NEOSTECKER S (trade name, manufactured by NICCA CHEMICAL CO., LTD.) [Foam stabilizer]
AMPHITOL 20N (trade name, manufactured by Kao Corporation)

[Substrate]
Transparent polyethylene terephthalate film (manufactured by Mitsubishi Chemical Corporation, thickness: 75 μm)

(Preparation of Coating Agent 1)

Into a 200 mL stainless steel pot, 7.3 parts by mass of Diamond 1, 83.6 parts by mass of EVAFANOL HA-170, 0.1 part by mass of NEOSTECKER S and 9.0 parts by mass of AMPHITOL 20N were put and stirred at 4000 rpm for 15 minutes by using a homomixer (trade name: T.K HOMODisper (Model 2.5) manufactured by PRIMIX Corporation). Thereafter, the mixture was filtered through #2000 plain gauze, thereby obtaining a coating agent base. No aggregate was observed on the plain gauze. Subsequently, the coating agent base was stirred at 100 rpm to generate bubbles by using a mechanical mixer (trade name: Ken Mix Aicoh Premier manufactured by Aicohsha Manufacturing Co., Ltd.). Coating agent 1 was obtained in this manner. The bubble volume was determined by weighing 100 mL of the coating agent base in a graduated cylinder, reading the graduation at this time, next weighing Coating agent 1 in a 100 mL graduated cylinder, and reading the graduation at this time. The volume of Coating agent 1 was 1.25 times (the volume proportion of bubbles was 25% by volume based on the volume of the portions excluding the bubbles in the coating agent) the volume of the coating agent base.

(Preparation of Coating Agent 2)

Coating agent 2 was prepared by the same method as that for preparing Coating agent 1 except that Diamond 2 was used instead of Diamond 1.

(Preparation of Coating Agent 3)

Coating agent 3 was prepared by the same method as that for preparing Coating agent 1 except that the volume proportion of bubbles was set to 66% by volume.

(Preparation of Coating Agent 4)

Coating agent 4 was prepared by the same method as that for preparing Coating agent 1 except that EK-61 was used instead of EVAFANOL HA-170.

(Preparation of Coating Agent 5)

Coating agent 5 was prepared by the same method as that for preparing Coating agent 1 except that the amount of Diamond 1 blended was set to 6.6 parts by mass, the amount of EVAFANOL HA-170 blended was set to 75.3 parts by mass, the amount of AMPHITOL 20N blended was set to 8.2 parts by mass, and 9.8 parts by mass of gold particles were added before performing stirring using a homomixer.

(Preparation of Coating Agent 6)

Coating agent 6 was prepared by the same method as that for preparing Coating agent 1 except that NEOSTECKER S and AMPHITOL 20N were not added, the amount of Diamond 1 blended was set to 8.0 parts by mass, the amount of EVAFANOL HA-170 blended was set to 92.0 parts by mass, and stirring using a mechanical mixer was not performed.

(Preparation of Coating Agent 7)

Coating agent 7 was prepared by the same method as that for preparing Coating agent 1 except that Diamond 1 was not added, the amount of EVAFANOL HA-170 blended was set to 90.8 parts by mass, and the amount of AMPHITOL 20N blended was set to 9.1 parts by mass.

(Preparation of Coating Agent 8)

Coating agent 8 was prepared by the same method as that for preparing Coating agent 1 except that the amount of EVAFANOL HA-170 blended was set to 100 parts by mass, Diamond 1, NEOSTECKER S, and AMPHITOL 20N were not added, and stirring using a mechanical mixer was not performed.

The compositions of Coating agents 1 to 8, the contents of the respective components (based on the total mass of the coating agent), and the volume proportion of bubbles (based on the volume of the portions excluding the bubbles in the coating agent) are presented in Tables 1 and 2.

TABLE 1

| Coating agent | | Unit | 1 | 2 | 3 | 4 | 5 |
|---|---|---|---|---|---|---|---|
| Resin dispersion | EVAFANOL HA-170 | % by mass | 83.6 | 83.6 | 83.6 | — | 75.3 |
| | EK-61 | % by mass | — | — | — | 83.6 | — |
| First particle | Diamond 1 | % by mass | 7.3 | | 7.3 | 7.3 | 6.6 |
| | Diamond 2 | % by mass | — | 7.3 | — | — | — |
| Second particle | Gold particle | % by mass | — | — | — | — | 9.8 |
| Thickener | NEOSTECKER S | % by mass | 0.1 | 0.1 | 0.1 | 0.1 | 0.1 |
| Foam stabilizer | AMPHITOL 20N | % by mass | 9 | 9 | 9 | 9 | 8.2 |

| | | | | | | |
|---|---|---|---|---|---|---|
| Bubble | % by volume | 25 | 25 | 66 | 25 | 25 |

TABLE 2

| Coating agent | | Unit | 6 | 7 | 8 |
|---|---|---|---|---|---|
| Resin | EVAFANOL HA-170 | % by mass | 92 | 90.8 | 100 |
| dispersion | EK-61 | % by mass | — | — | — |
| First particle | Diamond 1 | % by mass | 8 | — | — |
| | Diamond 2 | % by mass | — | — | |
| Second particle | Gold particle | % by mass | — | — | — |
| Thickener | NEOSTECKER S | % by mass | — | 0.1 | — |
| Foam stabilizer | AMPHITOL 20N | % by mass | — | 9.1 | — |

| | | | | |
|---|---|---|---|---|
| Bubble | % by volume | — | 2.5 | — |

### Example 1

<Fabrication of Projection Screen>

Coating agent 1 was coated on one face of the substrate by using a slide bead coating apparatus (Desktop Coater, Model TC-3 manufactured by MITSUI ELECTRIC Co., Ltd.) so that the concentration of solid components became 50 g/m². Thereafter, this was placed in an oven at 105° C. for 30 minutes to be dried, thereby fabricating a projection screen including a light diffusion film. The thickness of the light diffusion film was 50 μm, the volume proportion of bubbles was 14% by volume based on the volume of the portions excluding the bubbles in the light diffusion film, the average diameter of the bubble was 1 μm, and the refractive index of the resin layer was 1.50. Incidentally, in the present Example, the refractive index of the resin layer was measured by using an ellipsometer (trade name: Desktop Type Spectroscopic Ellipsometer FE-5000S manufactured by Yamato Scientific Co., Ltd.). In addition, the volume proportion of bubbles and the average diameter of bubbles were measured by the method described above using a scanning electron microscope (trade name: SU5000 manufactured by Hitachi High-Technologies Corporation).

### Example 2

A projection screen was fabricated by the same method as that in Example 1 except that Coating agent 2 was used instead of Coating agent 1. Incidentally, the thickness of the light diffusion film was 50 μm, the volume proportion of bubbles was 14% by volume, the average diameter of bubbles was 1 μm, and the refractive index of the resin layer was 1.50.

### Example 3

A projection screen was fabricated by the same method as that in Example 1 except that Coating agent 3 was used instead of Coating agent 1. Incidentally, the thickness of the light diffusion film was 50 μm, the volume proportion of bubbles was 29% by volume, the average diameter of bubbles was 1 μm, and the refractive index of the resin layer was 1.50.

### Example 4

A projection screen was fabricated by the same method as that in Example 1 except that Coating agent 4 was used instead of Coating agent 1. Incidentally, the thickness of the light diffusion film was 50 μm, the volume proportion of bubbles was 14% by volume, the average diameter of bubbles was 1 μm, and the refractive index of the resin layer was 1.49.

### Example 5

A projection screen was fabricated by the same method as that in Example 1 except that Coating agent 5 was used instead of Coating agent 1. Incidentally, the thickness of the light diffusion film was 50 μm, the volume proportion of bubbles was 14% by volume, the average diameter of bubbles was 1 μm, and the refractive index of the resin layer was 1.50.

### Comparative Example 1

A projection screen was fabricated by the same method as that in Example 1 except that Coating agent 6 was used instead of Coating agent 1. Incidentally, the thickness of the light diffusion film was 50 μm and the refractive index of the resin layer was 1.50.

### Comparative Example 2

A projection screen was fabricated by the same method as that in Example 1 except that Coating agent 7 was used instead of Coating agent 1. Incidentally, the thickness of the light diffusion film was 50 μm, the volume proportion of bubbles was 14% by volume, the average diameter of bubbles was 1 μm, and the refractive index of the resin layer was 1.50.

### Comparative Example 3

A projection screen was fabricated by the same method as that in Example 1 except that Coating agent 8 was used instead of Coating agent 1. Incidentally, the thickness of the light diffusion film was 50 μm and the refractive index of the resin layer was 1.50.

<Evaluation>

The projection screens of Examples 1 to 5 and Comparative Examples 1 to 3 thus obtained were subjected to evaluation on the performance as a reflective screen and performance as a transmissive screen. Specifically, the sharpness and brightness of image when an image was projected by using a projector were evaluated according to the following procedure.

(Evaluation on Performance as Reflective Screen)

[Sharpness of Image]

An image was projected from the face on the light diffusion film side of the projection screen onto the projection screen by using a digital projector (trade name: EH-TW410 manufactured by SEIKO EPSON CORPORATION), the image projected on the projection screen from the projector side (light diffusion film side) was visually observed, and the sharpness of the image was evaluated in four grades according to the following criteria. The first and second grades were judged as acceptance. The results are presented in Table 3.

1: Contour of projected image is extremely clearly visible.

2: Contour of projected image is sufficiently visible.

3: Contour of projected image is thin and hardly visible.

4: Contour of projected image is blurred and invisible.

[Brightness of Image]

An image was projected from the face on the light diffusion film side of the projection screen onto the projection screen by using a digital projector (trade name: EH-TW410 manufactured by SEIKO EPSON CORPORATION), the image projected on the projection screen from the projector side (light diffusion film side) was visually observed, and the brightness of the image was evaluated in four grades according to the following criteria. The first and second grades were judged as acceptance. The results are presented in Table 3.

1: Projected image is extremely bright.

2: Projected image is bright.

3: Projected image is dark overall.

4: Projected image is dark and invisible.

(Evaluation on Performance as Transmissive Screen)

[Sharpness of Image]

An image was projected from the face on the light diffusion film side of the projection screen onto the projection screen by using a digital projector (trade name: EH-TW410 manufactured by SEIKO EPSON CORPORATION), the image projected on the projection screen from the opposite side to the projector (substrate side) was visually observed, and the sharpness of the image was evaluated in four grades according to the following criteria. The first and second grades were judged as acceptance. The results are presented in Table 3.

1: Contour of projected image is extremely clearly visible.

2: Contour of projected image is sufficiently visible.

3: Contour of projected image is thin and hardly visible.

4: Contour of projected image is blurred and invisible.

[Brightness of Image]

An image was projected from the face on the light diffusion film side of the projection screen onto the projection screen by using a digital projector (trade name: EH-TW410 manufactured by SEIKO EPSON CORPORATION), the image projected on the projection screen from the opposite side to the projector (substrate side) was visually observed, and the brightness of the image was evaluated in four grades according to the following criteria. The first and second grades were judged as acceptance. The results are presented in Table 3.

1: Projected image is extremely bright.

2: Projected image is bright.

3: Projected image is dark overall.

4: Projected image is dark and invisible.

TABLE 3

| | Coating | Reflective screen | | Transmissive screen | |
|---|---|---|---|---|---|
| | agent | Sharpness | Brightness | Sharpness | Brightness |
| Example 1 | Coating | 2 | 2 | 2 | 1 |
| | agent 1 | | | | |
| Example 2 | Coating | 2 | 1 | 2 | 2 |
| | agent 2 | | | | |
| Example 3 | Coating | 1 | 2 | 1 | 1 |
| | agent 3 | | | | |
| Example 4 | Coating | 2 | 2 | 1 | 1 |
| | agent 4 | | | | |
| Example 5 | Coating | 1 | 2 | 1 | 1 |
| | agent 5 | | | | |
| Comparative | Coating | 3 | 2 | 3 | 2 |
| Example 1 | agent 6 | | | | |
| Comparative | Coating | — | 4 | — | 4 |
| Example 2 | agent 7 | | | | |
| Comparative | Coating | — | 4 | — | 4 |
| Example 3 | agent 8 | | | | |

From the results in Table 3, it can be seen that the projection screen of the present invention exhibits excellent visibility as it makes it possible to project a sharp image in the case of being used as a reflective screen and a transmissive screen.

### REFERENCE SIGNS LIST

1: first particle, 2: resin, 3: bubble, 4: substrate, 5: light diffusion film, 6: second particle.

1. A light diffusion film comprising a resin layer and a first particle and a bubble contained in the resin layer, wherein
a refractive index of the first particle is larger than a refractive index of the resin layer.

2. The light diffusion film according to claim 1, further comprising a second particle having a refractive index smaller than the refractive index of the resin layer.

3. A coating agent for forming a light diffusion film, the coating agent comprising a resin composition, a first particle, and a bubble, wherein
a refractive index of the first particle is larger than a refractive index of a resin layer formed from the resin composition.

4. The coating agent for forming a light diffusion film according to claim 3, further comprising a second particle having a refractive index smaller than the refractive index of the resin layer.

5. A coating agent for forming a light diffusion film, the coating agent comprising a resin composition, a first particle, and a blowing agent, wherein
a refractive index of the first particle is larger than a refractive index of a resin layer formed from the resin composition.

6. The coating agent for forming a light diffusion film according to claim 5, further comprising a second particle having a refractive index smaller than the refractive index of the resin layer.

7. A method for manufacturing a coating agent for forming a light diffusion film, the method comprising a step of introducing a bubble into a coating agent base containing a resin composition and a first particle having a refractive index larger than a refractive index of a resin layer formed from the resin composition.

8. The method for manufacturing a coating agent for forming a light diffusion film according to claim 7, wherein the coating agent base further contains a second particle having a refractive index smaller than the refractive index of the resin layer.

9. A method for manufacturing a projection screen, the method comprising:
a step of forming a particle-containing resin composition layer containing a resin composition, a first particle, and a bubble; and
a step of obtaining a light diffusion film including a resin layer and a first particle and a bubble contained in the resin layer by curing the particle-containing resin composition layer, wherein
a refractive index of the first particle is larger than a refractive index of the resin layer formed from the resin composition.

10. The method for manufacturing a projection screen according to claim 9, wherein the particle-containing resin composition layer further contains a second particle having a refractive index smaller than the refractive index of the resin layer.

11. The method for manufacturing a projection screen according to claim 9, wherein the particle-containing resin composition layer is formed by coating a substrate with a coating agent for forming a light diffusion film, the coating agent comprising a resin composition, a first particle, and a bubble, wherein a refractive index of the first particle is larger than a refractive index of a resin layer formed from the resin composition.

12. The method for manufacturing a projection screen according to claim 11, wherein the coating agent for forming a light diffusion film is obtained by introducing a bubble into a coating agent base for forming a light diffusion film containing the resin composition and the first particle.

13. The method for manufacturing a projection screen according to claim 10, wherein the particle-containing resin composition layer is formed by coating a substrate with a coating agent for forming a light diffusion film, the coating agent comprising a resin composition, a first particle, and a bubble, wherein a refractive index of the first particle is larger than a refractive index of a resin layer formed from the resin composition, further comprising a second particle having a refractive index smaller than the refractive index of the resin layer.

14. The method for manufacturing a projection screen according to claim 13, wherein the coating agent for forming a light diffusion film is obtained by introducing a bubble into a coating agent base for forming a light diffusion film containing the resin composition, the first particle, and the second particle.

15. A method for manufacturing a projection screen, the method comprising:
a step of forming a particle-containing resin composition layer containing a resin composition, a first particle, and a blowing agent; and
a step of obtaining a light diffusion film including a resin layer and a first particle and a bubble contained in the resin layer by performing bubbling of the blowing agent and curing of the particle-containing resin composition layer, wherein
a refractive index of the first particle is larger than a refractive index of the resin layer formed from the resin composition.

16. The method for manufacturing a projection screen according to claim 15, wherein the particle-containing resin composition layer further contains a second particle having a refractive index smaller than the refractive index of the resin layer.

17. The method for manufacturing a projection screen according to claim 15, wherein the particle-containing resin composition layer is formed by coating a substrate with a coating agent for forming a light diffusion film, the coating agent comprising a resin composition, a first particle, and a blowing agent, wherein a refractive index of the first particle is larger than a refractive index of a resin layer formed from the resin composition.

18. The method for manufacturing a projection screen according to claim 16, wherein the particle-containing resin composition layer is formed by coating a substrate with a coating agent for forming a light diffusion film, the coating agent comprising a resin composition, a first particle, and a blowing agent, wherein a refractive index of the first particle is larger than a refractive index of a resin layer formed from the resin composition, further comprising a second particle having a refractive index smaller than the refractive index of the resin layer.

19. The method for manufacturing a projection screen according to claim 9, wherein the projection screen is a reflective screen.

20. The method for manufacturing a projection screen according to claim 9, wherein the projection screen is a transmissive screen.

21. A projection screen comprising the light diffusion film according to claim 1.

22. The projection screen according to claim 21, wherein the projection screen is a reflective screen.

23. The projection screen according to claim 21, wherein the projection screen is a transmissive screen.
